(19) United States
(12) Patent Application Publication
(10) Pub. No.: US 2017/0120730 A1
(43) Pub. Date: May 4, 2017

(54) Active Fragrance Dispersion Apparatus And Method

(71) Applicant: Kraco Enterprises, LLC., Compton, CA (US)

(72) Inventors: Lingere D. Goddard, Carson, CA (US); John J. Fiumefreddo, Huntington Beach, CA (US)

(21) Appl. No.: 15/341,304

(22) Filed: Nov. 2, 2016

Related U.S. Application Data
(60) Provisional application No. 62/249,682, filed on Nov. 2, 2015.

(51) Int. Cl. B60H 3/00; B05B 17/06; B05B 7/24; B05B 12/12

(52) U.S. Cl. CPC B60H 3/0035; B05B 12/122; B05B 17/0607; B05B 7/2489

(57) ABSTRACT

An apparatus for dispensing fragrance includes a housing defining an interior chamber, a reservoir containing a liquid fragrance, and a fragrance actuator operatively coupled with the reservoir and directing liquid fragrance from the reservoir for exposure to the chamber or the environment when activated. A power source is coupled with the fragrance actuator. The power source provides power to the fragrance actuator when a sensor detects the presence of a user near the apparatus. A method of dispersing fragrance within a vehicle from a fragrance dispensing apparatus having a sensor and a fragrance actuator includes detecting the presence of a person in a vehicle with the sensor, and activating the fragrance actuator to direct fragrance from the apparatus into the vehicle.

### CROSS-REFERENCE

This application claims the benefit of U.S. Provisional Patent Application Ser. No. 62/249,682, filed Nov. 2, 2015 (pending), the disclosure of which is incorporated by reference herein in its entirety.

### TECHNICAL FIELD

The present invention relates generally to dispersing fragrance, and more particularly to apparatus and methods for actively dispersing fragrance.

### BACKGROUND

The use of air fresheners and other devices for providing or dispersing fragrance are generally known in the art. Conventional air fresheners or fragrance dispersing devices may generally be configured as passive devices, providing little or no control of the amount of fragrance dispersed by such devices. A need exists for improved apparatus and methods for dispersing fragrance to optimize the effectiveness and enjoyment of fragrances.

### SUMMARY

The present invention provides apparatus and methods for dispersing fragrances. While the invention will be described in connection with certain embodiments, it will be understood that the invention is not limited to these embodiments. On the contrary, the invention includes all alternatives, modifications and equivalents as may be included within the spirit and scope of the present invention.

According to one aspect of the present invention, an apparatus for dispersing fragrance includes a housing defining a first chamber and a fragrance emanator received in the housing and communicating with the first chamber. An oxygen generator disposed within the housing provides oxygen to the first chamber and receives power from a battery coupled with the oxygen generator. Vents in the housing communicate with the first chamber to facilitate the flow of air from the first chamber to the exterior of the housing. The apparatus may further include a solar cell on the housing and electrically coupled with the battery.

In another aspect, an apparatus for dispensing fragrance includes a housing defining an interior chamber, a reservoir containing a liquid fragrance, and a fragrance actuator operatively coupled with the reservoir and directing liquid fragrance from the reservoir for exposure to the chamber or the environment when activated. A power source is coupled with the fragrance actuator. The power source provides power to the fragrance actuator when a sensor detects the presence of a user near the apparatus.

In another aspect, a method of dispersing fragrance within a vehicle from a fragrance dispensing apparatus having a sensor and a fragrance actuator includes detecting the presence of a person in a vehicle with the sensor, and activating the fragrance actuator to direct fragrance from the apparatus into the vehicle.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 is a perspective view of an exemplary apparatus for dispersing fragrance in accordance with the principles of the present disclosure.

FIG. 2 is a perspective view of the apparatus of FIG. 1, illustrating one mode of operation.

FIG. 3 is an exploded perspective view of the apparatus of FIG. 1.

FIG. 4 is a schematic illustration depicting components of the apparatus of FIG. 1.

FIG. 5 is a perspective view of another exemplary apparatus for dispersing fragrance in accordance with the principles of the present disclosure.

FIG. 6 is a perspective view of the apparatus of FIG. 5, illustrating one mode of operation.

FIG. 7 is an exploded perspective view of the apparatus of FIG. 5.

### DETAILED DESCRIPTION

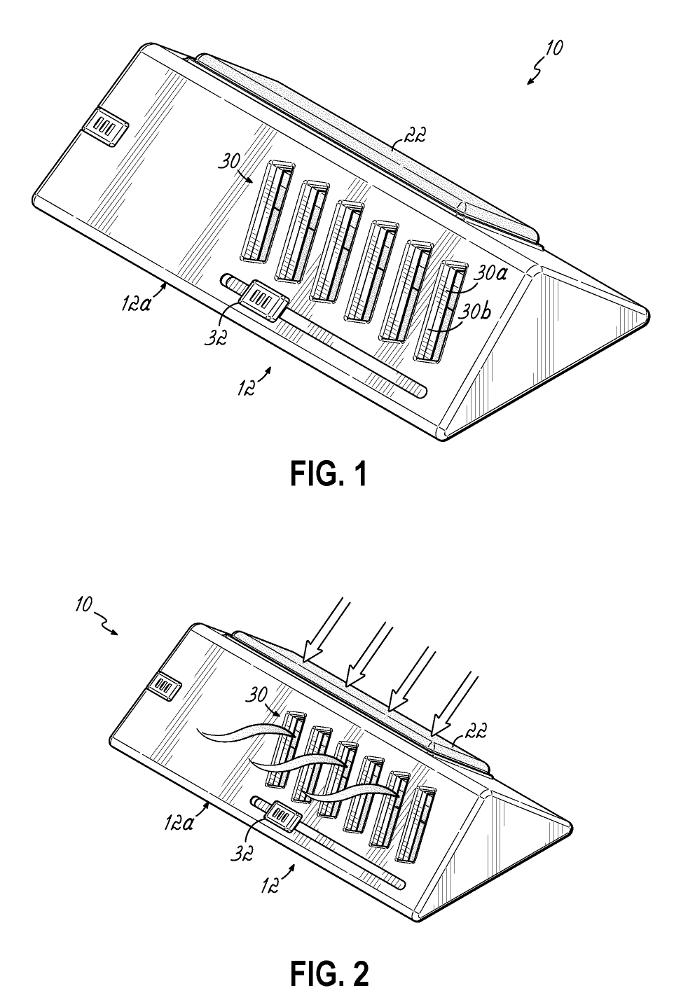

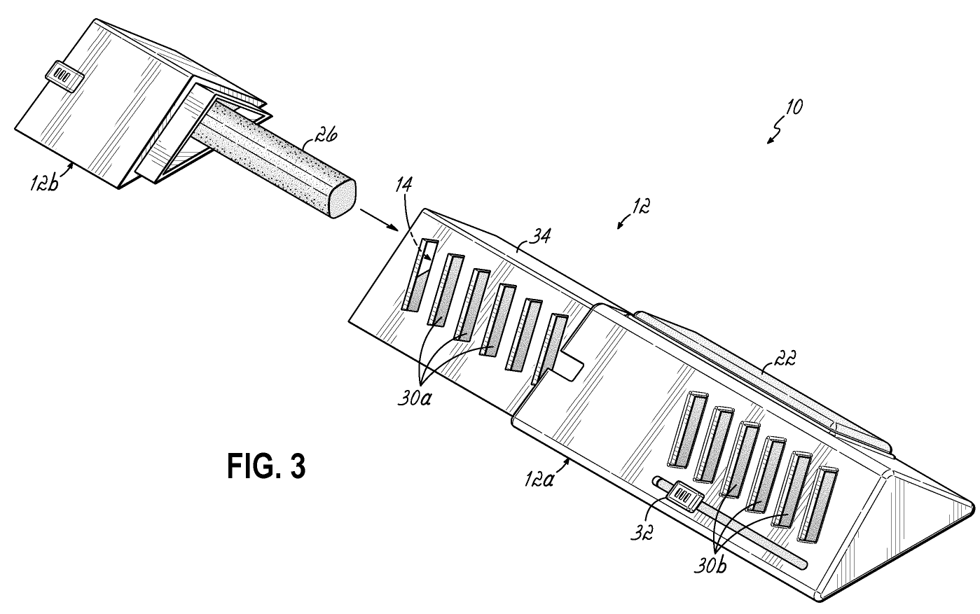

FIGS. 1-4 depict an exemplary apparatus 10 for dispersing fragrance in accordance with the principles of the present disclosure. The apparatus 10 may be particularly useful for providing fragrance in rooms and other enclosed spaces, such as interiors of automobiles or other vehicles, for example. In the embodiment shown, the apparatus 10 includes a housing 12 defining an interior chamber 14. The housing 12 includes a first housing portion 12a and a second housing portion 12b that are couplable together to define the housing structure. It will be appreciated, however, that the housing 12 may alternatively comprise only a single component, or may comprise more than two components that may be coupled together to define the housing structure.

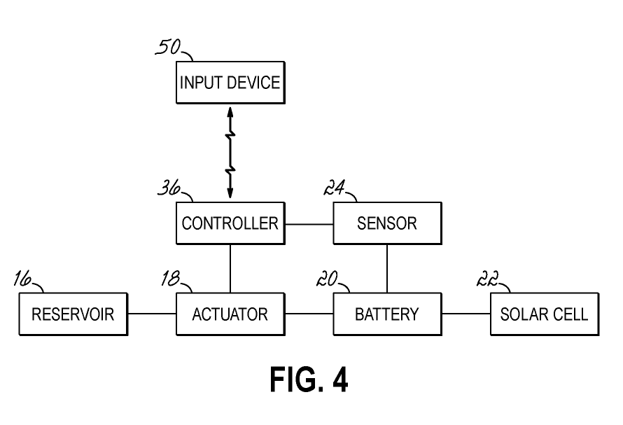

With reference to the schematic illustration depicted in FIG. 4, the apparatus 10 further includes a reservoir 16 at least partially disposed in the housing 12 and containing a liquid fragrance or other voliziable material that may be dispersed or otherwise exposed to the environment to create a pleasing odor. A fragrance actuator 18 is operatively coupled with the reservoir 16 and directs liquid fragrance from the reservoir 16 for exposure to the environment when activated. The liquid fragrance may be dispersed directly to the environment, or may be first directed into the interior chamber 14 for subsequent exposure to the environment. A power source at least partially disposed within the housing 12 is operatively coupled with the fragrance actuator 18 and provides power to the fragrance actuator 18 to direct liquid fragrance from the reservoir 16 when the fragrance actuator 18 is activated. In the embodiment shown, the power source comprises a battery 20 disposed within the housing 12. Additionally or alternatively, the power source may include a solar, or photovoltaic, cell 22 for charging the battery 20 or, alternatively, providing power directly to the fragrance actuator 18.

The apparatus 10 may further include one or more sensors 24 configured to detect the presence of a person proximate the apparatus 10. For example, if the apparatus 10 is used to dispense fragrance in a vehicle, the sensor 24 may be configured to detect when a person is located within the vehicle, or at least within close proximity of the vehicle, such as just before the person enters the vehicle. In operation, when the sensor 24 detects the presence of a person proximate the apparatus 10, the power source 20, 22 provides power to the fragrance actuator 18 to direct liquid from the reservoir 16 for exposure to the environment.

In the embodiment shown, the apparatus 10 further includes a fragrance emanator 26 disposed in the interior chamber 14 and positioned to receive liquid fragrance from the reservoir 16 when the fragrance actuator 18 is activated. The emanator 26 may comprise, for example, an absorbent or porous material, such as paper, cardboard, polymeric material, ceramic material, or any other material suitable for receiving and retaining a liquid fragrance so that the liquid fragrance may thereafter dispersed to the environment. In this embodiment, the fragrance actuator 18 may comprise any suitable structure for directing the liquid fragrance from the reservoir to the emanator 26, such as, for example, valves, pumps, bladders, diaphragms, or any other suitable devices.

The apparatus 10 may further include one or more devices configured to cause a flow of air to be directed over the emanator 26 to thereby facilitate dispersing fragrance to the environment. As non-limiting examples, such devices may include oxygen generators, fans, or other suitable structure. Vents 30 may be provided in the housing 12 for communication with the interior chamber 14 to facilitate the dispersion of fragrance through the vents 30 to the exterior of the housing 12. The apparatus 10 may further include an adjustment mechanism whereby a user may selectively adjust the degree to which the vents 30 are open to the interior chamber 14. In the embodiment shown, adjustable vents 30 are provided by a slide mechanism 32 provided on an exterior of the housing 12 and operatively coupled with a sliding panel 34 received within the first housing portion 12a. As the sliding mechanism 32 is moved to different positions, the alignment of apertures 30a in the panel 34 with corresponding apertures 30b in the first housing portion 12a is changed to thereby vary the degree opening between the interior chamber 14 and the environment.

The apparatus 10 may further include a controller 36 disposed in the housing 12 and communicating with the sensor 24 and the power source 20, 22. In response to the detection of the presence of a person by the sensor 24, the controller 36 activates the fragrance actuator 18 to direct liquid fragrance from the reservoir 16 for exposure to the environment. The controller 36 may also communicate with the one or more devices configured to cause air to flow over the emanator 36. In one embodiment, the controller 36 may include a number of pre-determined mechanical set points, such as high, medium, and low settings, for example, corresponding to a desired operation of the apparatus 10. For example, the settings may correspond to a desired frequency, duration, or intensity of the dispersion of fragrance to the environment, such as by control of the delivery of fragrance by the actuator 18 or by control of the flow of air to be provided over the emanator 26. The mechanical set points may be selected by a user of the apparatus 10, or the controller 36 may be preprogrammed to select a set point based on factors including signals received from the sensor 24.

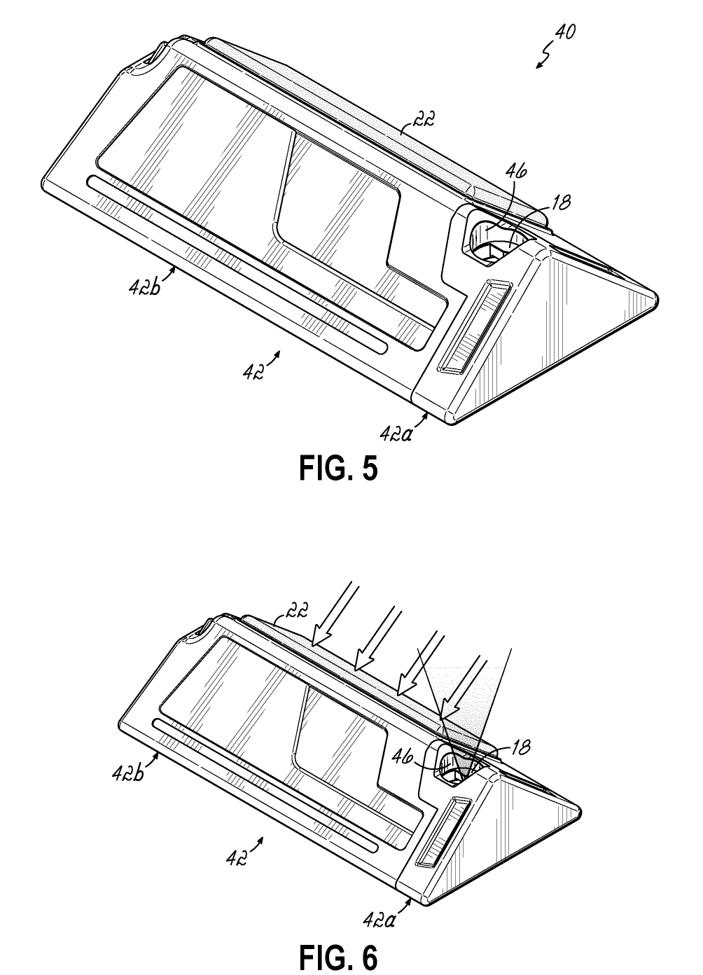

FIGS. 5-7 depict another exemplary apparatus 40 in accordance with the principles of the present disclosure for dispensing fragrance in an enclosed area, such as within a vehicle. Similar to the apparatus 10 shown and described above with respect to FIGS. 1-4, apparatus 40 includes a housing 42 formed by first and second housing portions 42a, 42b that are couplable together to define an interior chamber 44. Certain components of the apparatus 40 are similar to components of the apparatus 10 described with reference to FIG. 4 and have been similarly numbered. The apparatus 40 further includes a reservoir 16 containing a liquid fragrance or other volitizable material, and a fragrance actuator 18 operatively coupled with the reservoir 16 for directing liquid fragrance for dispersion to the environment when activated. In this embodiment, the fragrance actuator 18 comprises a nozzle, such as a piezoelectric nozzle, for atomizing liquid fragrance from the reservoir 16 and directing the atomized fragrance directly to the environment, such as through an aperture 46 provided in a top portion of the housing 42. In other embodiments, the nozzle may be configured to direct an atomized spray of fragrance within the interior chamber 44 for eventual dispersion to the environment in a manner similar to that described above.

The apparatus 40 further includes one or more sensors 24 configured to detect the presence of a person proximate the apparatus 40, and a power source operatively coupled with the fragrance actuator 18. When the sensor 24 detects the presence of a person proximate the apparatus 40, the power source provides power to the fragrance actuator 18 to deliver the atomized spray to the environment. In this embodiment, the power source includes a battery 20 disposed within the housing 42. Additionally or alternatively, the power source may include a solar, or photovoltaic, cell 22 for charging the battery 20. Alternatively, the solar cell may 22 be directly coupled with the fragrance actuator 18 for activating the fragrance actuator 18 to deliver liquid fragrance.

The apparatus 40 may further include a controller 36 disposed in the housing 42 and communicating with the sensor 24 and the power source 20, 22. In the embodiment shown, the controller 36 is configured to activate the fragrance actuator 18 in response to detection of the presence of the person by the sensor 24. Because the fragrance actuator 18 is only activated when the presence of a person is detected by the sensor 24, the apparatus 10, 40 efficiently disperses fragrance to the environment only when persons are present to perceive the fragrance.

In the embodiments described above with respect to FIGS. 1-7, the sensor 24 may comprise a passive infrared sensor that senses infrared light radiating from objects proximate the sensor 24. In other embodiments, the sensor 24 may comprise a radio frequency identification device (RFID) that may be carried by a user of the apparatus 10, 40. When the RFID is in close proximity to the apparatus 10, 40, a detector on the apparatus 10, 40 may receive signals from the RFID and indicate to the controller 36 that the presence of the user has been detected. In yet another embodiment, the apparatus 10, 40 may include one or more sensors 24 in the form of an accelerometer disposed on or in the housing 12, 42. The accelerometer may be configured to sense motion, such as motion that may be caused by a person opening or entering a vehicle, or the accelerometer may detect movement of the vehicle itself. In response to the detection of such motion, the controller 36 will activate the fragrance actuator 18 to direct liquid fragrance to the environment.

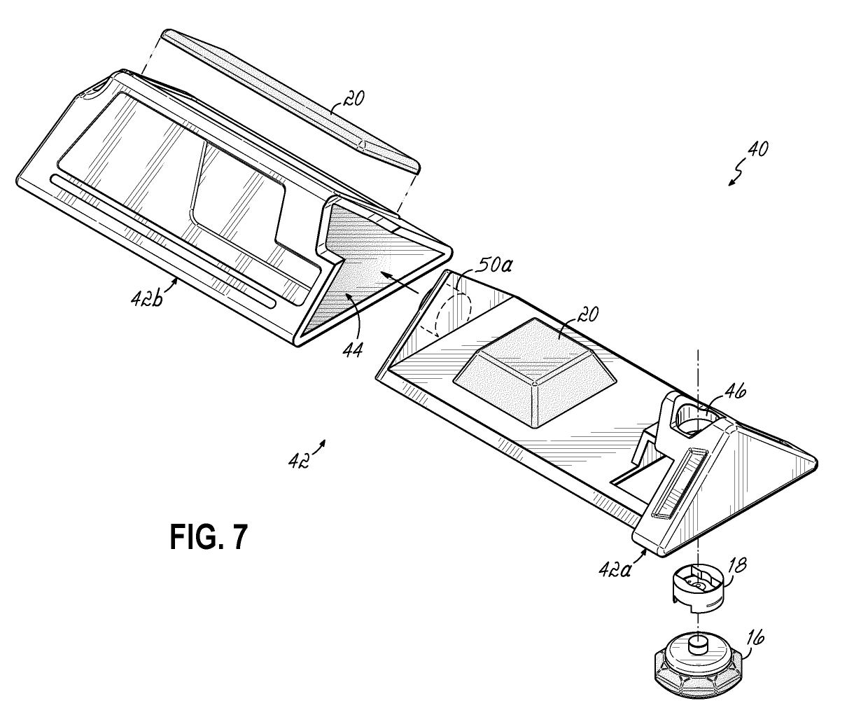

The controllers 36 described above with respect to the embodiments of FIGS. 1-7 may additionally or alternatively be configured to receive commands from an input device 50, and vary operation of the apparatus 10, 40 based on the information received from the input device 50. In one embodiment depicted in FIG. 7, the apparatus 40 includes an input device 50a provided on the housing 42 for this purpose. In other embodiments, the controller 36 may be configured to communicate with an input device 50 using wireless communication technology suitable for exchanging data over short distances. As a non-limiting example, such wireless communication technology may include Bluetooth® technology, whereby the controller 36 may receive information from a user input device 50, such as a smartphone or other suitable personal digital device. In response to receiving such information, the controller 36 may change the operation of various components of the apparatus 10, 40 to dispense fragrance in a manner desired by the user. As non-limiting examples, the controller 36 may vary operation of one or more of the fragrance actuator 18, the power source 20, 22, or devices for providing air flow within or from the apparatus 10, 40 to thereby control an intensity, duration, or frequency of delivery of fragrance from the apparatus 10, 40.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

What is claimed is:

1. An apparatus for dispensing fragrance, the apparatus comprising:
a housing defining an interior chamber;
a reservoir containing a liquid fragrance;
a fragrance actuator operatively coupled with the reservoir and directing liquid fragrance from the reservoir for exposure to the chamber or the environment when activated;
a power source operatively coupled with the fragrance actuator; and
a sensor configured to detect the presence of a user proximate the apparatus;
the power source providing power to the fragrance actuator when the sensor detects the presence of the user.

2. The apparatus of claim 1, further comprising:
a fragrance emanator disposed in the chamber and receiving liquid fragrance from the reservoir when the fragrance actuator is activated.

3. The apparatus of claim 1, wherein the fragrance actuator comprises a nozzle for dispensing atomized fragrance into the chamber or the environment.

4. The apparatus of claim 3, wherein the nozzle is a piezoelectric nozzle.

5. The apparatus of claim 1, wherein the power source comprises at least one of a battery or a solar cell.

6. The apparatus of claim 1, further comprising:
a controller communicating with the sensor and the power source;
the controller activating the fragrance actuator in response to the detection of the presence of an occupant by the sensor.

7. The apparatus of claim 1, wherein the sensor comprises at least one of:
a passive infrared sensor;
an accelerometer; or
a radio frequency identification device.

8. The apparatus of claim 1, further comprising:
an oxygen generator communicating with the chamber and providing oxygen to facilitate dispersing fragrance to the environment.

9. The apparatus of claim 6, wherein the controller is configured to receive information from an input device, the controller controlling operation of at least one of the power source or the fragrance actuator based on the information.

10. The apparatus of claim 9 wherein the controller adjusts operation of at least one of the power source or the fragrance actuator to vary at least one of a duration, intensity, or frequency of the fragrance being exposed to the chamber or the environment.

11. The apparatus of claim 9, wherein the controller is configured to receive information using wireless communication technology.

12. A method of dispersing fragrance within a vehicle from a fragrance dispensing apparatus having a sensor and a fragrance actuator, the method comprising:
detecting the presence of a person in a vehicle with the sensor; and
activating the fragrance actuator to direct fragrance from the apparatus into the vehicle.

13. The method of claim 12, further comprising;
providing power to the fragrance actuator from a power source that includes a solar cell.

14. The method of claim 13, wherein the apparatus further includes a controller, the method further comprising:
controlling at least one of the fragrance actuator or the power source with the controller to vary at least one of a duration, intensity, or frequency of the fragrance being directed into the vehicle.

15. The method of claim 14, further comprising:
wirelessly receiving information at the controller related to a desired performance of the apparatus; and
controlling the fragrance actuator or the power source based on the received information.
